(19) United States
(12) Patent Application Publication
(10) Pub. No.: US 2016/0015000 A1
(43) Pub. Date: Jan. 21, 2016

(54) HANDHELD ANIMAL WASHING APPARATUS

(71) Applicant: Ryan Andew Diez, Valencia, CA (US)

(72) Inventor: Ryan Andew Diez, Valencia, CA (US)

(21) Appl. No.: 14/805,464

(22) Filed: Jul. 21, 2015

Related U.S. Application Data
(60) Provisional application No. 62/026,798, filed on Jul. 21, 2014.

(51) Int. Cl. A01K 13/00; B05B 7/24; A47K 5/12; B05B 1/14

(52) U.S. Cl. CPC A01K 13/001; B05B 1/14; B05B 7/244; A47K 5/12

(57) ABSTRACT

A handheld device for wetting, washing and/or rinsing animals, objects or people. The invention comprises a water and/or soap dispenser and an encapsulating element that creates a 360 degree spray of water. The invention optionally allows for soap to be dispensed through a soap dispenser into the jet streams to create a soapy water stream. This device quickly bathes and rinses animals and in particular dogs. This invention is also drawn to a method of washing/rinsing animals, objects or people using a handheld washing/rinsing device.

This application claims benefit to U.S. provisional application Ser. No. 62/026,798 filed Jul. 21, 2014, the disclosure of which is incorporated in its entirety by reference herein.

### FIELD OF INVENTION

This invention is directed to a handheld device for wetting, washing and/or rinsing animals, objects or people.

### BACKGROUND OF INVENTION

The present invention generally relates to handheld devices that wash animals, objects or humans, and more specifically canines, referred to herein as “dogs”.

Other devices known in the art simply spray water and/or dispense soap from a single point. With the known technology, soap and water can only be dispensed where the spray is aimed. The current known devices do not distribute soapy water or rinse the dog from all sides, unless the user changes the direction of the spray. Using known devices is time consuming because it does not distribute the water and/or soap over the entire dog. Ultimately, currently known devices do not provide full coverage of soap and an entire rinse.

The present invention is a handheld washing device, which encapsulates an animal in streams of soap and/or water, leaving no area of an animal's body dry or un-bathed. The devices described herein spray water from all sides simultaneously, which shortens the time it takes to wash any animal, more specifically dogs. It also effectively cleans an animal's coat while washing the entirety of its body.

### SUMMARY OF THE INVENTION

The present invention is a washing device, comprising a soap dispenser and an encapsulating element. The soap dispenser has a first end and a second end. The first end couples to a water source. The second end is coupled to the encapsulating element. Said encapsulating element has a series of openings. When water pressure is increased from the water source, water flows freely from the water source through the first end of the soap dispenser, and is released through the second end of the soap dispenser into the encapsulating element, and is ultimately released through the openings of the encapsulating element.

In another embodiment, the present invention is a wetting or rinsing device, comprising a water dispenser and an encapsulating element. The waster dispenser has a first end and a second end. The first end couples to a water source. The second end is coupled to the encapsulating element. Said encapsulating element has a series of openings. When water pressure is increased from the water source, water flows freely from the source of water through the first end of the water dispenser, and is released through the second end into the encapsulating element, and is ultimately released through the openings of the encapsulating element.

In one embodiment of the invention, the soap dispenser has a first end and a second end, and further comprises a handle, a soap reservoir, and a nozzle. The nozzle is located at the second end of the handle, and the first end comprises female threading such that it can be coupled to a garden hose of any size. The female threading also couples to various adapters. Adapters are rigid or flexible. Adapters couple to various fittings, hoses, connectors or water sources, including but not limited to a spigot, sink, shower head, water tank, or pipe.

In one embodiment of the invention, the water dispenser has a first end and a second end, and further comprises a handle and a nozzle. The nozzle is located at the second end, and the first end comprises female threading such that it can be coupled to a garden hose of any size in any country. The female threading also couples to various adapters. Adapters connect to various water sources, including but not limited to a spigot, sink, shower, hose, water tank, or pipe.

In one embodiment of the invention, the soap dispenser further comprises a means to release soap and to stop the release of soap into the stream of water flowing through the soap dispenser. Said means of releasing soap is any device known in the art, including but not limited to a turn dial, switch, lever, trigger or button that opens/closes a valve or opening, such that it controls release of soap into the stream of water going through the soap dispenser.

In an alternative embodiment, the soap dispenser comprises a soap reservoir, and a straw or straw-like structure, wherein the straw or straw-like structure is inside the soap dispenser such that one end of the straw or straw-like structure is submerged in soap. The straw or straw-like structure is connected to a pump, lever, trigger or other means, which dispenses soap into the stream of water going through the soap dispenser.

In another embodiment, a soap cartridge containing a soap mixture, or a soap mixture contained in a sealed reservoir, is affixed to the handle element, such that a specified amount of soap is released into the water stream for a specific period of time. The soap mixture is sealed with a plastic or rubber top, and more preferably a foil, or foil-like top, such that when the soap cartridge is inserted into the handle the seal is punctured, thus releasing the soap mixture into the handle and out the encapsulating element.

In an additional embodiment, the soap dispenser has a handle and a soap reservoir, wherein the soap reservoir is contained completely inside the handle. Soap is added to the soap reservoir via an inlet, wherein the inlet has a first opening on the exterior of the handle and a second opening which empties into the soap dispenser. The inlet is optionally at the top, bottom, or either side of the handle. The first opening of the inlet is sealed via any known means, including, but not limited to a cap with male/female threading, a plug, a screw or any other stopper.

In any embodiment described herein, “soap” means detergent, cleanser, bleach, shampoo, antiseptic, or any other cleaning agent.

Many soap dispensers can be incorporated into the invention. The soap dispenser can be any number of soap dispenser known in the art, including but not limited to devices described in U.S. Pat. No. 6,257,786, U.S. Pat. No. 6,571,989, U.S. Pat. No. 7,510,128, U.S. Pat. No. 6,151,728, U.S. Pat. No. 6,000,626, U.S. Pat. No. 2,619,385, all of which are incorporated by reference herein in their entirety.

In another embodiment, the encapsulating element comprises one or more encapsulating tubes and a t-joint. The encapsulating tubes have a first end and a second end. The t-joint has two or more ends. One end of the t-joint is called a dispenser connector, and couples to the second end of a soap dispenser or the second end of a water dispenser. The remaining one or more ends of the t-joint, called herein element connectors, couple with one or more encapsulating tubes. In a preferred embodiment, the t-joint has two element connectors, each element connector is coupled to the first end and second end of the encapsulating tube to create a circular, oval, triangle, hexagon, or other polygon shaped encapsulating element.

In any embodiments described herein, the dispenser connector is permanently or removeably coupled to the soap dispense or water dispenser by any known means in the art, including but not limited to male/female threading, any adhesive, glue, epoxy, industrial strength plastic adhesive, spring tension or spring tension like push buttons.

In another embodiment, the t-joint has two element connectors. Each element connector is coupled with the first end of an encapsulating tube to create a horseshoe, crescent moon, circle with a small gap, or any other open shaped encapsulating element. The second end of each encapsulating tube is coupled to a stopper, which prevents water from escaping from the second end of the encapsulating tube. In a preferable embodiment the encapsulating tubes are flexible such that they are able to push apart and slide around an animal, object or person, and then flex back into place such that the animal is surrounded by the encapsulating tubes.

In another embodiment, the t-joint contains three or more element connectors, and each is coupled to the first end of an encapsulating tube. The second end of each encapsulating tube is coupled to a stopper, which prevents water from escaping from the second end of the encapsulating tube. This embodiment creates an open multi-dimensional spherical, elliptical or any other polygon shape. In a preferable embodiment the encapsulating tubes are flexible such that they are able to push apart and slide around an animal, object or person, and then flex back into place such that the animal is surrounded by the encapsulating tubes.

In any of the embodiments described herein, the stopper at second end of an encapsulating tube is optionally removable or permanently coupled to the second end of the encapsulating tube. The stopper is coupled to the second end of the encapsulating tube by any known means in the art, including but not limited to male/female threading, glue, any adhesive, any industrial strength adhesive, epoxy, spring tension or spring tension like push buttons.

In any of the embodiments described herein, the encapsulating tube comprises one curved, bent, or straight segment. Alternatively, in any of the embodiments described herein, the encapsulating tube is comprised of two or more curved, bent or straight, segments. The segments of the encapsulating tube, sometimes referred to herein as segments, have a first end and second end. The first end is coupled to the second end of the encapsulating tube by any known means in the art, including but not limited to male/female threading, glue, any adhesive, any industrial strength adhesive, epoxy, spring tension or spring tension like push buttons.

In a preferred embodiment, each segment has female threading on the first end and male threading on the second end, such that the first end is coupled with the second end. In another preferred embodiment the segments of the encapsulating tube have a connector permanently affixed to the first end. In this embodiment, the first end slightly larger than the second end and glides over the second end to fit snuggly around the second end, in a manner that prevents water from escaping. Optionally, the connector locks into place around the second end. Optionally, the connector is fitted with an o-ring to prevent water from escaping. The connector is made out any suitable waterproof material, including but, not limited, to any rubber, plastic or metal.

In an alternative embodiment, the encapsulating element, as described in any embodiment herein, is a single molded structure, comprising a t-joint, an encapsulating element, one or more encapsulating tubes and optionally one or more stoppers. This embodiment can be made using injection mold manufacturing techniques or by any other means known to one of skill in the art.

In an alternative embodiment, the soap dispenser and encapsulating element, as described in any embodiment herein, are manufactured as a single molded structure, comprising soap dispenser (or any portion thereof, such as the soap dispenser casing), a t-joint, an encapsulating element, one or more encapsulating tubes and optionally one or more stoppers. This embodiment may also be manufactured in two molded structures that are then coupled or sealed together to form a single complex molded structure. This embodiment can be made using injection mold manufacturing techniques or by any other means known to one of skill in the art.

In another embodiment, the t-joint and t-joint connector are coupled to the second end of said soap dispenser permanently by glue, epoxy, melting, stitching, or melding segments together, or any other known method of permanently coupling the materials. In another embodiment the t-joint, t-joint connector, and the soap dispenser are made using injection mold manufacturing techniques or by any other means known to one of skill in the art.

In another embodiment the encapsulating element is coupled to the second end of said soap dispenser, such the encapsulating element is easily removable. In one embodiment the encapsulating element is coupled to the soap dispenser via female and male threading, such that the encapsulating element is easily twisted into place, and easily removed. In another embodiment the encapsulating element is coupled via spring tension push buttons, or spring tension like push buttons. A user presses on the buttons, which compresses a spring and in turn releases the encapsulating element. The embodiments in this paragraph are preferable because they allow for convenient storage of the washing device, and allow for the opportunity to air dry.

In one embodiment the t-joint is coupled to the first end of an encapsulating tube, such that the t-joint is easily removable. In another embodiment the encapsulating element is coupled to the soap dispenser via female and male threading, such that the encapsulating element is easily twisted into place, and easily removed. In yet another embodiment the encapsulating element is coupled via spring tension push buttons, or spring tension like push buttons. A user presses on the buttons to release the encapsulating element. The embodiments in this paragraph are preferable because they allow for convenient storage of the washing device, and allow for the opportunity to air dry.

Any part of the encapsulating element comprising one or more encapsulating tubes, a t-joint and a t-joint connector, wholly or in part, is preferably comprised of plastic, rubber, hose material, metal, metal alloid, or any other flexible or rigid water proof material. In another embodiment, the encapsulating element, wholly or in part, is constructed of a cylindrical rubber, rubber-like material, or another flexible material, that expands when water-pressure is applied. When the water pressure is removed the material returns to its original flaccid form. An example of this embodiment uses a “Pocket Hose” or hose made of materials similar to those of the Pocket Hose to create any portion of the encapsulating element.

In another embodiment the encapsulating element, wholly or in part, is constructed out of plastic, metal, rubber, nylon, polyurethane, polyethylene, PVC, or synthetic or natural rubbers polyethylene (LDPE and especially LLDPE), PTFE (Teflon), stainless steel, and other metals. In this embodiment the encapsulating elements made out of flexible materials are optionally reinforced with fibers or steel cord, and such encapsulating elements are reinforced by any common methods, including but not limited to braiding, spiraling, knitting and wrapping of fabric plies. In further embodiments encapsulating elements contain corrugations or bellows, optionally having circumferential or helical reinforcement rings to maintain these corrugated or bellowed structures.

In any embodiments described herein, “coupling”, “couples”, “coupled”, “attaching”, “attaches”, “attached”, “connecting”, “connects” or “connected” means permanently or removeably affixing or coupling two pieces together by any known means in the art, including by not limited to male/female threading, any adhesive, glue, epoxy, industrial strength plastic adhesive, stitching, melting, melding, spring tension, or any other means of coupling described herein. Male/female threading may be comprised of any waterproof rigid material including but not limited to plastic, rubber, metal, or metal alloid.

Further to any embodiment described herein, the encapsulating element is a circle, rectangle, square, hexagon, octagon, triangle, half circle, crescent moon, a “C”, horseshoe, oval, or any other similar shapes.

Further to any embodiment described herein, the encapsulating element has an inner surface, and said inner surface has numerous holes, or relief holes, herein after called “openings” to allow for the passage of water and/or soap to escape.

In any embodiment described herein, the encapsulating element is a multitude of sizes to accommodate different sized and weighted animals, objects, or people. The size of the encapsulating element correlates to the size of the animal, object or person being washed. The numbers of openings also correlate as the size of the encapsulating element. Generally, diameter of the encapsulating element is as small as 4 inches and as large as 40 inches, with as few as 5 openings and as many as 500 openings. Preferably the diameter is between 11 and 16 inches, with 30 to 45 openings, wherein said openings are placed approximately 1 inch away from adjacent openings.

In any embodiment described herein, the encapsulating element is comprised of encapsulating tubes, sometimes referred to herein in as tubes, wherein the encapsulating tubes are hollow cylindrical or elliptical tubes having an inner surface, and the openings are placed in one or more lines on the inner surface of the encapsulating tube. In one embodiment the openings are bunched together, such that more streams of water arise from one part of the encapsulating tube, and fewer streams of water arise from another part of the encapsulating tube. The openings are placed between 0.1 inch and 2 inches away from adjacent openings.

In a more preferred embodiment, the openings are placed equidistant from other openings, such that there is an even distribution of water streams around the encapsulating element, creating streams of water that appear to be spokes on a wheel. The openings are placed between 0.1 inch and 2 inches away from adjacent openings.

In another embodiment, the encapsulating element is comprised of encapsulating tubes, wherein the tubes are hollow elongated elliptical, square, rectangular, rounded rectangle, flattened circle, or another shape of tube having an inner surface, wherein the inner surface is planar and wide enough to have openings in two or more parallel lines, such that the openings spray substantially parallel streams of water towards the center of the encapsulating element. The lines of openings are 0.1 inch and 2 inches apart. In one embodiment the openings are bunched together, such that more streams of water arise from one part of the encapsulating tube, and fewer streams of water arise from another part of the encapsulating tube. The openings are placed between 0.1 inch and 2 inches away from adjacent openings. In a more preferred embodiment, the openings are placed equidistant from other openings, such that there is an even distribution of water streams around the encapsulating element. The openings are placed between 0.1 inch and 2 inches away from adjacent openings.

In any of the embodiments described herein, the openings have a diameter such that when average water pressure is applied a stream of water is released from the openings with sufficient force to quickly wet the exterior of an animal, person or object. The exact diameter of the openings depends on the number of openings and size of the encapsulating elements. In a preferred embodiment, the diameter of an opening is approximately 1/32 inch to 3/32 inch.

Another embodiment of this invention is a method of washing an animal, object or person using any of the embodiments of the devices described herein. The user holds the water dispenser handle, turns the dispenser on and passes the encapsulating element back and forth over the animal, object or person and thus saturating the entirety of the animal, object or person with water. When the user is satisfied with the amount of water applied to the animal, object, or person, the means for dispensing soap is activated, allowing soap from the soap reservoir to mix with the water and soak the animal, object, or person with soapy water. The user disengages the means for dispensing soap, and clean water exits the openings for a thorough rinse (360 degrees). In an embodiment wherein the animal is a dog, the rinse and wash includes the dog's stomach and under side area.

Another embodiment of this invention is a method of rinsing an animal, object or person using any of the embodiments of the devices described herein. The user holds the water dispenser handle, turns the dispenser on and passes the encapsulating element back and forth over the animal, object or person and thus saturating the entirety of the animal, object or person with water. In an embodiment wherein the animal is a dog, the rinse includes the dog's stomach and under side area.

### BRIEF DESCRIPTION OF THE DRAWINGS

FIG. 1 is a side view of the washing device.

FIG. 2A illustrates an example of a horse-shoe shaped encapsulating element.

FIG. 2B illustrates an example of a circular encapsulating element.

FIG. 2C illustrates an example of another encapsulating element.

FIG. 2D illustrates an example of a hexagonal shaped encapsulating element.

FIG. 2E illustrates an example of an elliptical encapsulating tube.

FIG. 2F illustrates an example of a flattened encapsulating tube.

FIG. 2G illustrates an example of an encapsulating element comprising an elliptical encapsulating tube with two lines of openings.

FIG. 3A illustrates an example of an encapsulating element made of multiple segments.

FIG. 3B illustrates another example of an encapsulating element made of two segments.

FIG. 3C illustrates the encapsulating element segments, simply called herein segments, as they are stored.

FIG. 4 is an open side view of the soap dispenser and t-joint, and illustrates one means of coupling the t-joint to the soap dispenser.

FIG. 4A is another view of the soap dispenser.

FIG. 5A illustrates a cross-section of side view of a water dispenser and a mechanism for modulating water flow.

FIG. 5B illustrates a cross-section of side view of a soap dispenser and a mechanism for releasing soap.

FIG. 6 illustrates a method of using the washing device.

### DETAILED DESCRIPTION OF THE DRAWINGS

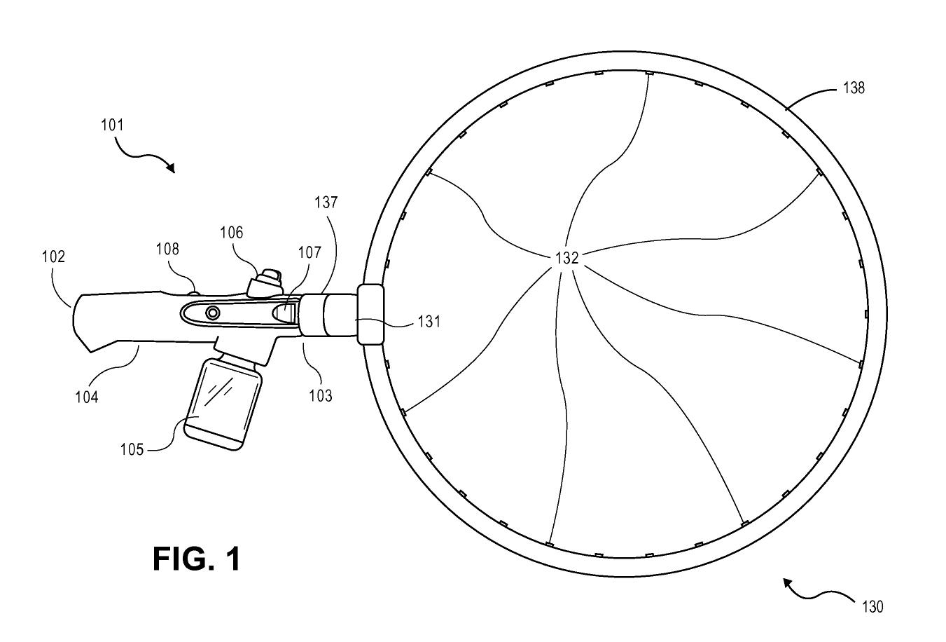

The handheld washing device as shown in FIG. 1 comprises a soap dispenser 101 and an encapsulating element 130. Soap dispenser 101 is coupled to encapsulating element 130. Encapsulating element 130 comprises encapsulating tube 138, t-joint 131, and connector 137. Soap dispenser 101 comprises handle encasement 104, having a first handle end 102 and a second handle end 103. Second handle end 103 is removably coupled to connector 137. Soap dispenser 101 further comprises soap reservoir 105 and soap modulator 106. Soap reservoir 105 is removably coupled to handle encasement 104 by any common means known in the art, including but not limited to male/female threading, snap-locking or any other known means of attachment. Soap dispenser further comprises release button 107. When release button 107 is depressed with sufficient force, encapsulating element 130 can be easily removed. Soap dispenser 101 further comprises water pressure modulator 108 which adjusts the rate of water flow from the water source to encapsulating element 130. Encapsulating tube 138 has a smooth circumferential inner surface lined with multiple openings 132, which release water inward, towards the center of encapsulating tube 138.

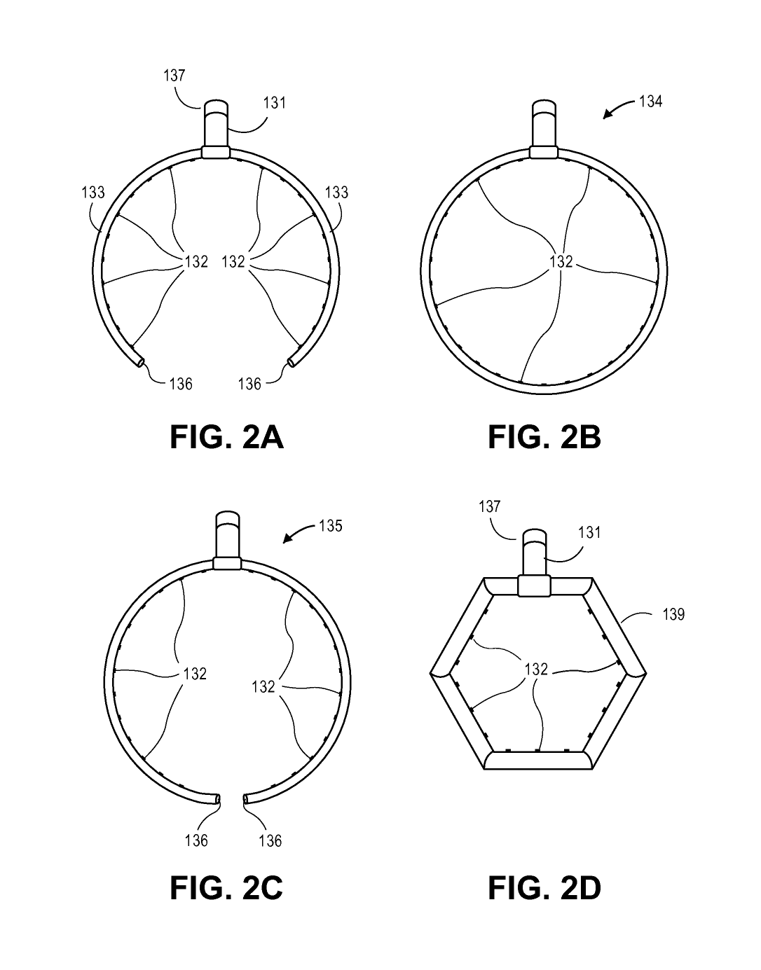

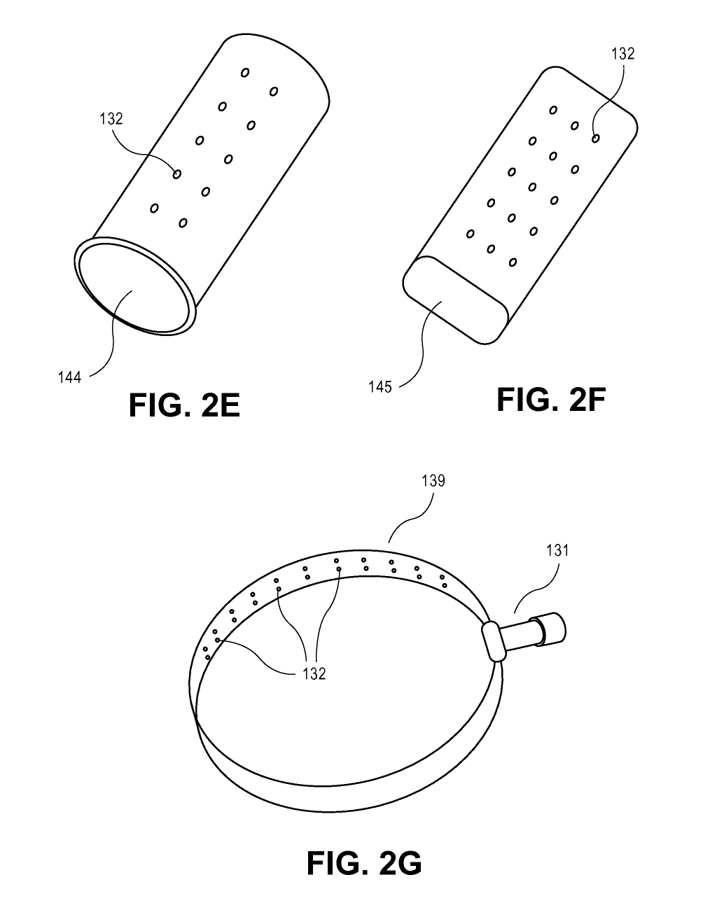

The encapsulating element as shown in FIG. 2A comprises t-joint connector 137, t-joint 131, and two horseshoe-shaped encapsulating tubes 133. Each horseshoe-shaped encapsulating tube 133 has a first end that is coupled with t-joint 131 and a second end that is sealed by stopper 136. Each horseshoe-shaped encapsulating tube 133 further comprises an inner surface lined with multiple openings 132, which release water inward.

FIG. 2B illustrates a circular encapsulating element 134. Circular encapsulating element 134 is one molded segment comprising a t-joint connector, t-joint and circular encapsulating tube, as opposed to separate segments connected together as shown in FIGS. 1 and 2A. Circular encapsulating element 134 further comprises an inner surface lined with multiple openings 132, which release water inward towards the center of encapsulating element 134. Circular encapsulating element 134 is made by mold injection or any other means known in the art, and it is made from materials listed herein in at paragraphs [0028] and [0029], and more preferably is made of molded plastic, molded rubber or tubing.

FIG. 2C illustrates an open-circle encapsulating element 135. Open-circle encapsulating element 135 is one molded segment comprising a t-joint connector, t-joint and “c” shaped or open circle shaped encapsulating tube, as opposed to separate segments connected together as shown in FIGS. 1 and 2A. Open-circle encapsulating element 135 has two ends, which are closed by stopper 136. Open-circle encapsulating element 135 further comprises an inner surface lined with multiple openings 132, which release water inward towards the center of open-circle encapsulating element 135. Open-circle encapsulating element 135 is made by mold injection or any other means known in the art, and is made from materials listed herein in at paragraphs [0028] and [0029], and more preferably is made of molded plastic, molded rubber or tubing.

The encapsulating element as shown in FIG. 2D comprises t-joint connector 137, t-joint 131, and a hexagonal-shaped encapsulating tube 139. Hexagonal-shaped encapsulating tube 139 has a first end and second end, which are coupled with t-joint 131. Hexagonal-shaped encapsulating tube 139 further comprises an inner surface lined with multiple openings 132, which release water inward.

FIG. 2E illustrates portion of an elliptical encapsulating tube 144, comprising an inner surface, which has openings 132 positioned in two lines. The flatness of 144 causes the two lines of openings 132 to release water in substantially parallel streams to adjacent openings.

FIG. 2F illustrates another portion of a flattened elliptical encapsulating tube 145, comprising an inner surface, which has openings 132 positioned in three lines. The flatness of 145 causes the three lines of openings 132 to release water in substantially parallel streams to adjacent openings.

FIG. 2G illustrates encapsulating element 139, which comprises elliptical encapsulating tube 144 having openings 132 positioned in two lines and t-joint 131. In this embodiment, water streams flowing from openings 132 spray inward toward the center of encapsulating element 139, and water streams from the two lines are substantially parallel.

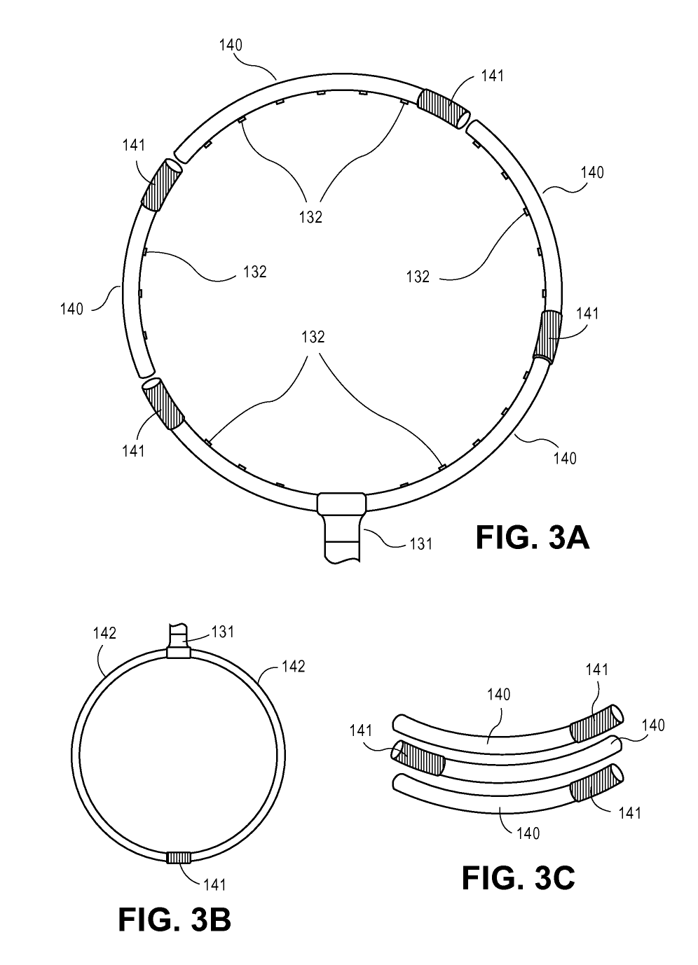

FIG. 3A illustrates yet another encapsulating element comprising segmented encapsulating tubes 140, sometimes herein referred to as segments 140, and encapsulating tube connectors 141, sometimes herein referred to as connectors 141 or tube connectors 141. The diameter of tube connector 141 is such that it fits snuggly with segment 140 with enough friction to prevent water from escaping at this juncture. Additional material, including but not limited to rubber lining or o-rings, is optionally added to 140 or 141 to ensure a water-tight seal. Alternatively, tube connector 141 and segment 140 are coupled via male and female threading, or another water-tight means. Alternatively, 141 represents one end of segmented encapsulating tube 140, wherein connector 141 comprises a means for coupling with the other end of segmented encapsulating tube 140, such means for coupling includes but is not limited to male and female threading. Segment 140 and connector 141 are optionally made from materials listed herein in at paragraphs [0028] and [0029].

FIG. 3B illustrates yet another encapsulating element comprising semicircular encapsulating tubes 142 and encapsulating tube connector 141. Diameter of encapsulating tube connector 141 is such that it fits snuggly with semicircle encapsulating tubes 142 with enough friction to prevent water from escaping at this juncture, or by other means including but not limited to those identified herein at paragraph [0064]. In this embodiment, 141 alternatively represents one end of segmented semicircle encapsulating tube 142, wherein 141 comprises a means for coupling with the other end of segmented semicircle encapsulating tubes 142, such means for coupling includes but is not limited to male and female threading. 142 and 141 are optionally made from materials listed herein in at paragraphs [0028] and [0029].

FIG. 3C illustrates segmented encapsulating tubes 140 and encapsulating tube connectors 141 in a configuration for easy storage.

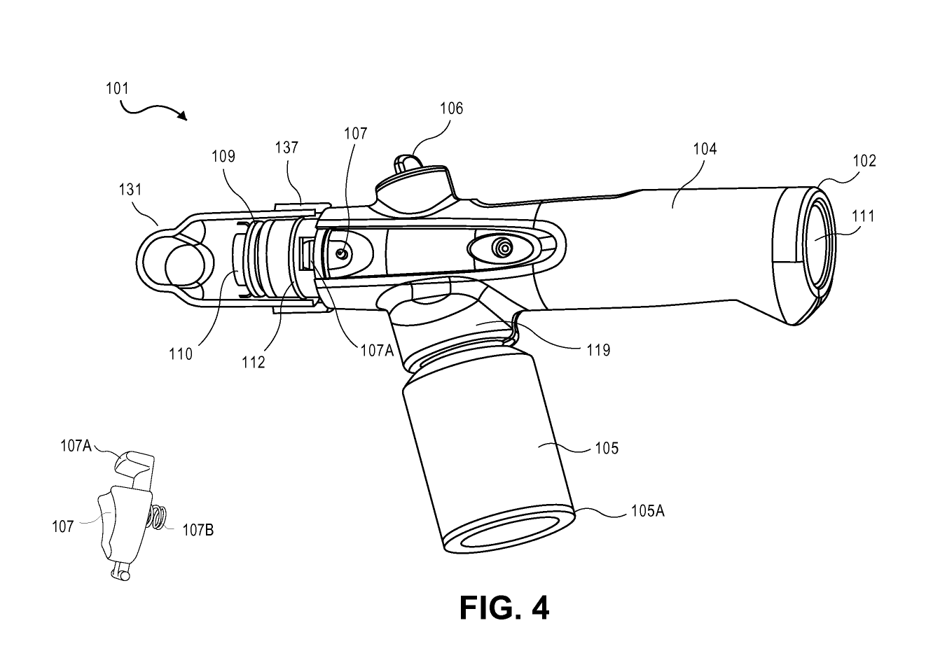

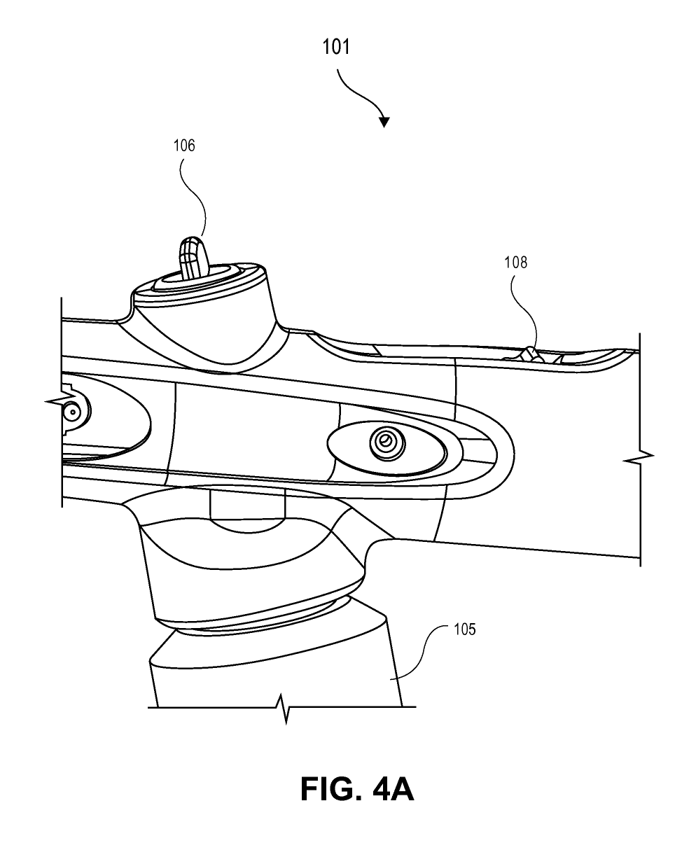

Soap dispenser 101 and t-joint 131 as shown in FIG. 4 illustrates further detail of the device. In this embodiment, the first handle end 102 is fitted with threading 111, such that it couples with a standard garden hose from any country or an adapter that links the soap dispenser to a water source including a dispenser, spigot, shower head, faucet or other common source of water. The top end of soap reservoir 105 is linked to the soap dispenser via a reservoir attachment site 119, and the bottom end of 105 is coupled with soap reservoir plug 105A. 105A is optionally removably or permanently affixed to soap reservoir 105. This view also shows fitted o-ring 112, which is preferably made of a type of rubber. Fitted o-ring 112 buffers friction and prevents water from escaping at the junction between t-joint 131 and soap dispenser 101. A side view of nozzle 110 is illustrated and provides a release point for the stream of water that flows through soap dispenser 101.

FIG. 4 also illustrates release button 107, which further comprises release notch 107A, and a cross-sectional view of t-joint 131 and t-joint connector 137. The diameter of t-joint connector 137 is just wide enough to fit snugly around t-joint 131. At the bottom of t-joint connector 137, where t-joint connector couples with soap dispenser 101, a ridge narrows the circumference of t-joint connector 137 to the same diameter of t-joint 131. T-joint 131 and t-joint connector 137 are permanently coupled such that they create a small gap between the bottom of t-joint connector 137 and the bottom of t-joint 131. Release notch 107A is sized such that it fits into the gap between the bottom of t-joint 131 and the bottom of t-joint connector 137. Thus, the ridge catches release notch 107A, and securely couples an encapsulating element to soap dispenser 101. When a user depresses release button 107 with sufficient pressure, spring 107B is compressed, and releases notch 107A moves inward, such that the ridge of t-joint connector 137 can move freely and t-joint 131 can be removed from soap dispenser 101.

FIG. 4A illustrates water pressure modulator 108. A user can increase or decrease the flow of water through soap dispenser 101 by moving the modulator forward and backwards.

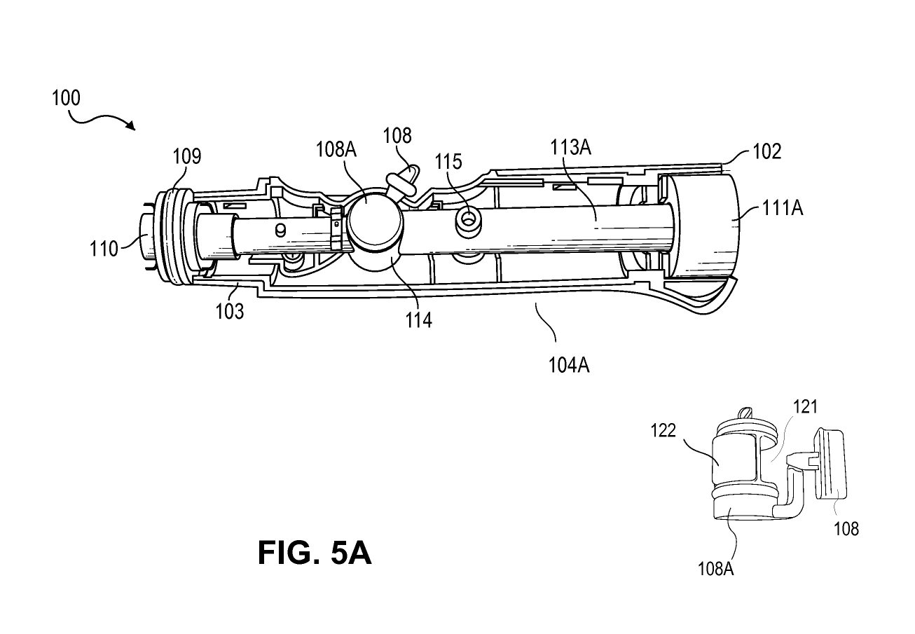

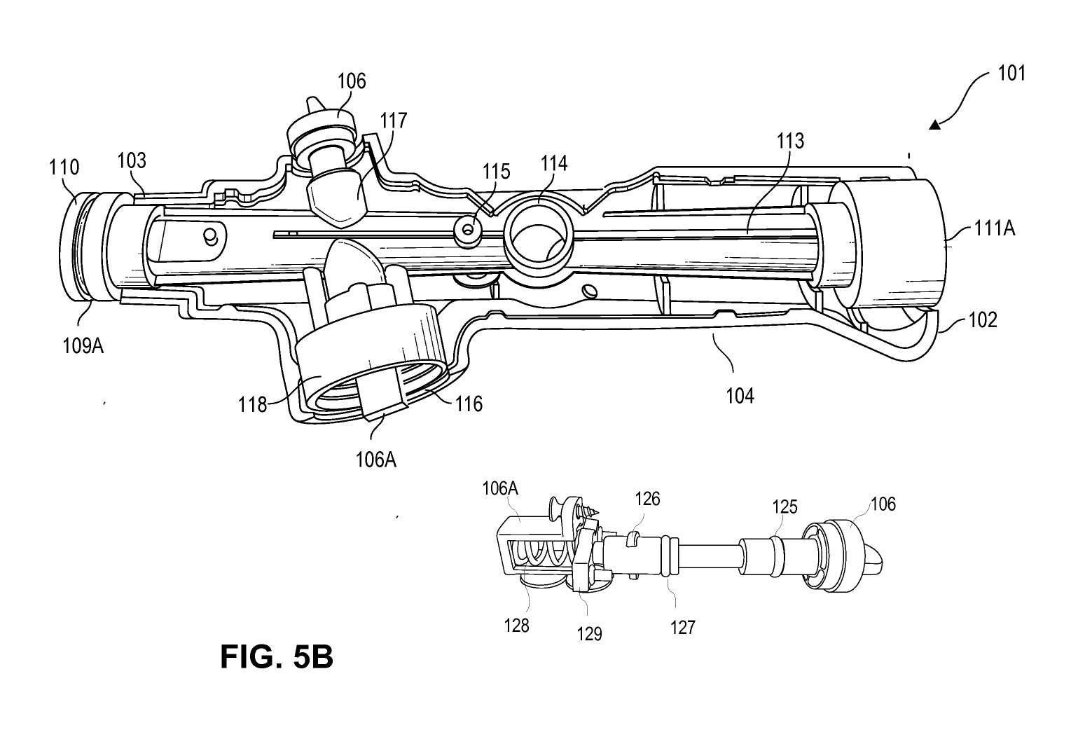

FIG. 5A illustrates a cross-sectional view of a water dispenser 100. Water dispenser 100 comprises a handle encasement 104A having a first handle end 102 and a second handle end 103. Water dispenser 100 further comprises flow tube 113A. At the first end of flow tube 113A is a means for attaching to water source 111A. In one embodiment, the means for attaching to a water source is female threading, suitable to couple with male threading of a hose. At second handle end 103 is nozzle 110. The second end is fitted with rubber o-ring 109, which creates a seal between flow tube 113A and an encapsulating element. Point of attachment 115, affixes flow tube 113A to handle encasement 104A. A preferred embodiment uses a screw as a means of attachment. Finally, this view illustrates water pressure modulator 108 permanently connected to cylindrical valve 108A, which is fitted to valve housing 114. Cylindrical valve 108A further comprises opening 121, which is substantially the same size as the interior portion of flow tube 113A. When a user moves 108 in one direction, it turns round valve 108A, such that opening 121 aligns with flow tube 113A to allow maximum water flow. When a user moves 108 in the opposite direction, it turns round valve 108A, such that 122 blocks flow tube 113A to minimize or stop the water flow. 122 is made of any suitable material, including but not limited to rubber or plastic.

Soap dispenser 101 as shown in FIG. 5B illustrates a cross-section of handle encasement 104 having a first handle end 102 and a second handle end 103. Soap dispenser 101 further comprises flow tube 113. First end of flow tube 113 comprises a means for attaching to a water source 111A. In one embodiment, the means for coupling to a water source 111A is female threading, suitable to couple with male threading of a hose. In alternative embodiments, the means for coupling to a water source 111A are any suitable means for coupling described herein. Nozzle 110 and indent 109A, which houses an o-ring, are illustrated as well. Point of attachment 115, affixes flow tube 113 to handle encasement 104. A preferred embodiment uses a screw as a means of attachment. Finally, this view illustrates soap modulator 106. The action of turning soap modulator 106 enables soap to be pulled into the water stream. Soap modulator 106 is connected to 106A, which houses spring 128. When soap modulator 106 is pushed down and turned 90 degrees, spring 128 is depressed, 129 moves downward, and 126 catches and locks the mechanism in place. The resulting action releases soap into the water stream. When soap modulator 106 is turned another 90 degrees it prevents soap from being released into the water stream by unlocking 126, which allows spring 128 to expand, and 129 moves upward stopping or slowing the flow soap into the water stream. The entire mechanism for modulating soap release is housed in 117. A means for coupling to a soap reservoir 118 is illustrated. In this embodiment female threading 116 couples with male threading of a soap reservoir. In alternative embodiments, the means for coupling to a soap reservoir are any suitable means for coupling described herein.

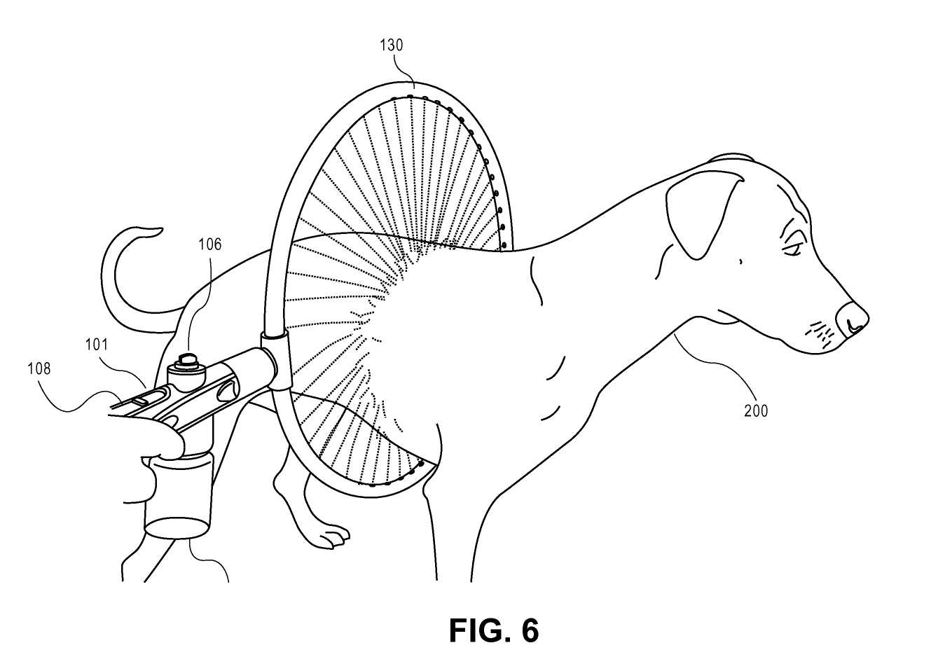

FIG. 6 illustrates a method of washing an animal wherein the user holds handle encasement 104, turns on water pressure modulator 108 to release water such that a water stream travels through soap dispenser 101, passes into encapsulating element 130 and is released via multiple openings 132. At the same time, user positions the encapsulating element around animal 200, moving the encapsulating element 130 back and forth over animal 200, ultimately soaking the animal with water such that water penetrates the animal's fur or coat. When the user is satisfied with the amount of water applied to the animal, user activates soap modulator 106 such that it releases soap (or another cleaning agent) into the water stream flowing through soap dispenser 101, soapy water passes through encapsulating element 130 and soapy water is released via multiple openings 132, ultimately soaking the animal with soapy water. When the user is satisfied with the amount of soap applied to animal 200, user disengages soap modulator 106, such that only clean water passed through encapsulating element 130 and exits openings 132. Again, user positions the encapsulating element around animal 200, moving the encapsulating element 130 back and forth over animal 200, thoroughly rinsing the animal.

1. An apparatus comprising a soap dispenser and an encapsulating element:
wherein said soap dispenser has a first end and a second end, said first end has a means to couple to a water source, and said second end couples to said encapsulating element;
wherein said encapsulating element has an inner surface, and said inner surface has openings; and
wherein water flows from said water source passing through the soap dispenser and the encapsulating element and exits via the openings.

2. An apparatus of claim 1, wherein said soap dispenser comprises a handle, a soap reservoir, and nozzle.

3. An apparatus of claim 1, further comprising a water pressure modulator.

4. An apparatus of claim 2, further comprising a means for releasing soap.

5. An apparatus of claim 1, wherein said second end is coupled to the encapsulating element via male and female threading.

6. An apparatus of claim 1, wherein said second end is coupled to the encapsulating element via spring tension push buttons.

7. An apparatus of claim 1 wherein said second end is permanently coupled to the encapsulating element.

8. An apparatus of claim 1, wherein the encapsulating element comprises an encapsulating tube, a t-joint and a t-joint connector.

9. An apparatus of claim 8, wherein said encapsulating tube is comprised of two or more segments.

10. An apparatus of claim 8, wherein said encapsulating tube is comprised of a flexible flaccid material, which expands when water pressure is applied, and returns to its original flaccid form when water pressure is removed.

11. An apparatus of claim 8, wherein the encapsulating tube, t-joint and t-joint connector comprise one solid molded structure.

12. An apparatus of claim 8, wherein the encapsulating tube is circular, elliptical, hexagonal, horse-shoe shaped, or open-circular shaped.

13. A method of washing an animal using an apparatus comprising a soap dispenser and an encapsulating element:
wherein said soap dispenser comprises a handle, a water pressure modulator, a means for releasing soap, a first end and a second end, wherein said first end couples to a water source, and said second end couples to the encapsulating element;
wherein said encapsulating element has an inner surface, and said inner surface has opening;
wherein a user holds the handle and activates water pressure modulator to release water such that a water stream travels through the soap dispenser into the encapsulating element is released via openings, and positions the encapsulating element around an animal, moving the encapsulating element back and forth over the animal such that water wets the animal;
wherein the user activates the means for dispensing soap, such that soap is released into the water stream travels through the soap dispenser into the encapsulating element is released via openings, and moves the encapsulating element back and forth over the animal such that soap and water penetrates covers the animal; and
wherein user disengages the means for releasing soap, such that only water travels through the soap dispenser into the encapsulating element is released via and moves the encapsulating element back and forth over the animal such that soap and water penetrates rinses the animal, leaving the animal clean and free of soap.
